(19) United States
(12) Patent Application Publication
(10) Pub. No.: US 2016/0107945 A1
(43) Pub. Date: Apr. 21, 2016

(54) BIOMATERIAL PROCESS AND APPARATUS

(71) Applicant: FREELAND HORTICULTURE LIMITED, Swanley Kent (GB)

(72) Inventors: George Aitchieson Norman LONGMUIR, Swanley Kent (GB); Patricio Christian HUDSON, Swanley Kent (GB)

(73) Assignee: FREELAND HORTICULTURE LIMITED, Swanley Kent (GB)

(21) Appl. No.: 14/892,691

(22) PCT Filed: May 20, 2014
(86) PCT No.: PCT/EP2014/060303

§ 371 Date: Nov. 20, 2015

(30) Foreign Application Priority Data
May 20, 2013 (GB) 1309040.2

(51) Int. Cl. C05F 9/04; B02C 23/14; C05F 9/02

(52) U.S. Cl. CPC C05F 9/04; C05F 9/02; B02C 23/14

(57) ABSTRACT

The invention relates to a process of manufacturing a growing medium from an initial material which is a by-product of a composting process and comprises a mixture of oversize biodegradable material and contaminants. The process comprises: removing contaminant objects from the initial material; removing mineral contaminants from the initial material; and subsequently defibrating the remaining material to produce a growing medium.

### FIELD OF THE INVENTION

This invention relates to a growing medium for use in agriculture, horticulture, floriculture or other similar applications, and also relates to an apparatus and method for manufacturing growing media.

### BACKGROUND OF THE INVENTION

Peat is a natural substance extracted from the ground and used as a growing medium for plants, trees and other biological life in horticulture, agriculture, floriculture and other similar applications. Peat may be mixed with other materials, such as bark fines and composted green waste, to produce a growing medium commonly referred to as compost. The peat is added to improve soil structure and increase acidity and has excellent water retention properties as it can retain water in dry conditions and also protects roots by maintaining a supply of air, even when exposed to large amounts of water.

Peat is a natural substance formed of partly decayed biological matter trapped in a flooded area which deprives it of oxygen. It forms over extended periods of time and is classified as a non-renewable fossil fuel. Moreover, extracting peat from the ground is expensive and in some circumstances can be damaging to the environment.

Green waste, such as hedge trimmings, tree trimmings, grass trimmings and other similar materials may be composted to produce a growing medium commonly called green compost. A typical composting process lasts 16 weeks, during which time the material is intermittently turned over and mixed while it decomposes. After this time has elapsed the majority of the material has biodegraded to a sufficient degree to be used as green compost. However, some material remains after this composting process and the remaining material typically comprises large pieces of biodegradable material, such as tree twigs and branches, and also non-biodegradable contaminants such as plastics, glass and metals. The remaining biodegradable material would take a longer period of time to decompose into useable compost and therefore is not seen as an economically viable material and is typically disposed of by landfill or other conventional waste disposal methods. This can be expensive and there are environmental, political, social and economic pressures which discourage this type of waste disposal.

### SUMMARY OF THE INVENTION

According to a first aspect of the invention, there is provided a process of manufacturing a growing medium from an initial material, wherein said initial material is a by-product of a composting process and comprises a mixture of oversize biodegradable material and contaminants, the process comprising:
removing contaminant objects from the initial material;
removing mineral contaminants from the initial material; and subsequently
defibrating the remaining material to produce a growing medium.

The step of defibrating the remaining material may comprise applying pressure to said material.

The step of defibrating the remaining material may comprise rotating said material to apply a shear force to the material.

The step of defibrating the remaining material may comprise reducing the size of the material such that it is able to pass through a spacing having a pre-determined size.

The spacing may be between 10 mm and 40 mm in size.

The step of defibrating the remaining material may comprise using a feed screw configured to press the material against a surface.

The step of removing contaminant objects may comprise removing objects which are larger than 80 mm in size.

The step of removing contaminant objects may comprise removing objects with a high specific gravity compared to water.

The step of removing contaminant objects may comprise passing said material through a water vortex system configured such that objects having a high specific gravity compared to water will sink through the water vortex and are removed from the system and objects having a lower specific gravity compared to water will pass across the top of the water vortex and be removed from the water vortex system.

The step of removing contaminant objects may comprise removing material which is smaller than 20 mm in size.

The step of removing contaminant objects from the initial material may comprise passing air over and/or through the initial material to remove lightweight objects.

The step of removing contaminant objects may comprise passing said material through a sorting unit comprising an optical identification system to identify contaminant objects and a means for removing the identified contaminant objects.

In one embodiment, the step of passing the material through the sorting unit may be carried out prior to the step of mechanically defibrating the remaining material to produce a growing medium.

Alternatively or additionally, the step of passing the material through the sorting unit may be carried out subsequent to the step of mechanically defibrating the remaining material to produce a growing medium.

The step of removing mineral contaminants from said initial material may comprise washing said initial material with water.

The process may further comprise the step of separating the growing medium produced by the defibration step into a small particle growing medium and a large particle growing medium.

According to another aspect of the invention, there is provided a growing medium manufactured by the process described above.

According to a further aspect of the invention, there is provided apparatus for manufacturing a growing medium from an initial material, wherein said initial material is a by-product of a composting process and comprises a mixture of oversize biodegradable material and contaminants, the apparatus comprising:
means for removing contaminant objects from said initial material;
means for removing mineral contaminants from said initial material; and
a defibration unit configured to defibrate the remaining material to produce a growing medium.

The defibration unit may be configured to press said remaining material against a surface.

The defibration unit may be configured to rotate said remaining material relative to a surface to shear said material.

The defibration unit may comprise a feed screw which rotates to urge said remaining material towards the surface.

The feed screw may comprise a helical fin extending along a longitudinal shaft and the surface comprises an aperture, wherein an axial spacing is formed between an end of the helical fin and the surface, such that defibrated material can pass along the axial spacing and exit the defibration apparatus via the aperture.

The axial spacing between the end of the helical fin and the surface may be between 15 mm and 25 mm in size.

The surface may comprise a recess disposed adjacent to the aperture, so that material being urged towards the surface by the feed screw will contact the recess.

The means for removing contaminant objects from said initial material may comprise a screen which comprises a plurality of apertures having a pre-determined size, such that objects in the initial material are removed according to their size.

The screen may comprise a plurality of apertures of size 80 mm, to remove objects which are larger than 80 mm in size.

The screen may comprise a plurality of apertures of size 20 mm, to remove objects which are smaller than 20 mm in size.

The means for removing contaminant objects from the initial material may comprise an air separator which passes air over and/or through the initial material to remove lightweight objects.

The means for removing contaminant objects from the initial material may comprise a water vortex separator comprising a tank in which water is caused to rotate in a vortex, wherein said initial material is fed into the top of the tank such that contaminant objects with a high specific gravity compared to water will sink through the water to an outlet in the bottom of the tank, and objects having a low specific gravity compared to water will float and be carried around the tank and be removed via an outlet in the top of the tank.

The means for removing contaminant objects from the initial material may comprise a sorting unit which comprises an optical identification system to identify contaminant objects and a means for removing those identified contaminant objects.

The apparatus may further comprise a screen configured to separate the defibrated growing medium produced by the processing unit into a small particle growing medium and a large particle growing medium.

According to another aspect of the invention, there is provided a defibrating unit for manufacturing a growing medium from a biodegradable material, comprising a feed screw and a surface, the feed screw being rotatable to urge biodegradable material against said surface, wherein the surface comprises a recess having edges, the biodegradable material being defibrated as it is urged against said surface and as it interacts with said edges of the recess.

The feed screw may comprise a longitudinal shaft and the surface comprises an aperture, a helical fin extends along the shaft so that an axial spacing is formed between an end of the helical fin and the surface to enable defibrated material to pass along said axial spacing through said aperture and exit the defibration unit.

The shaft and the surface may be movable relative to each other to alter the size of said axial spacing.

The axial spacing between the end of the helical fin and the surface may be between 15 mm and 25 mm in size.

The shaft may extend into the aperture and a radial spacing is formed between the shaft and the surface, through which defibrated material passes.

According to another aspect of the invention, there is provided a growing medium manufactured by the apparatus described above.

According to a further aspect of the invention, there is provided a growing medium manufactured from an initial material which is a by-product of a composting process and comprises a mixture of oversize biodegradable material and contaminants, the growing medium comprising a defibrated material having a bulk density of between 100 kilograms/cubic metre and 300 kilograms/cubic metre.

The pH of the growing medium may be between 5.0 and 8.0.

The electrical conductivity of the growing medium may be between 100 and 600 microSiemens/centimetre when determined using a medium:water ratio of 6:1.

According to further aspect of the invention, there is provided a blended growing medium at least partly comprising the growing medium described above.

### BRIEF DESCRIPTION OF THE DRAWINGS

Embodiments of the invention will now be described, by way of example only, with reference to the accompanying drawings, in which:

FIG. 1 shows a process diagram of an overall process of producing growing media;

FIG. 2 shows a process diagram for manufacture of a growing medium from the initial material;

FIG. 3 shows a detailed process diagram of the process of FIG. 2;

FIG. 4 shows an example of sorting apparatus used in the manufacture of a growing medium;

FIG. 5 shows an example of apparatus for removing dense objects, used in the manufacture of a growing medium;

FIG. 6 shows an example of washing apparatus used in manufacture of a growing medium;

FIG. 7 shows the defibration apparatus;

FIG. 8 shows a plan view of the defibration apparatus of FIG. 7;

FIG. 9 shows a plate of the defibration apparatus of FIGS. 7 and 8; and,

FIG. 10 shows examples of apparatus used to sort defibrated material.

### DETAILED DESCRIPTION

As previously explained, after a process of composting green waste material there remains a by-product material that is not economically viable to compost further. Specifically, the by-product material includes biodegradable material which is too large to compost in a conventional manner, such as braches and roots, as well contaminant objects such as plastics, glass and metals. Presently, there is little use for this material.

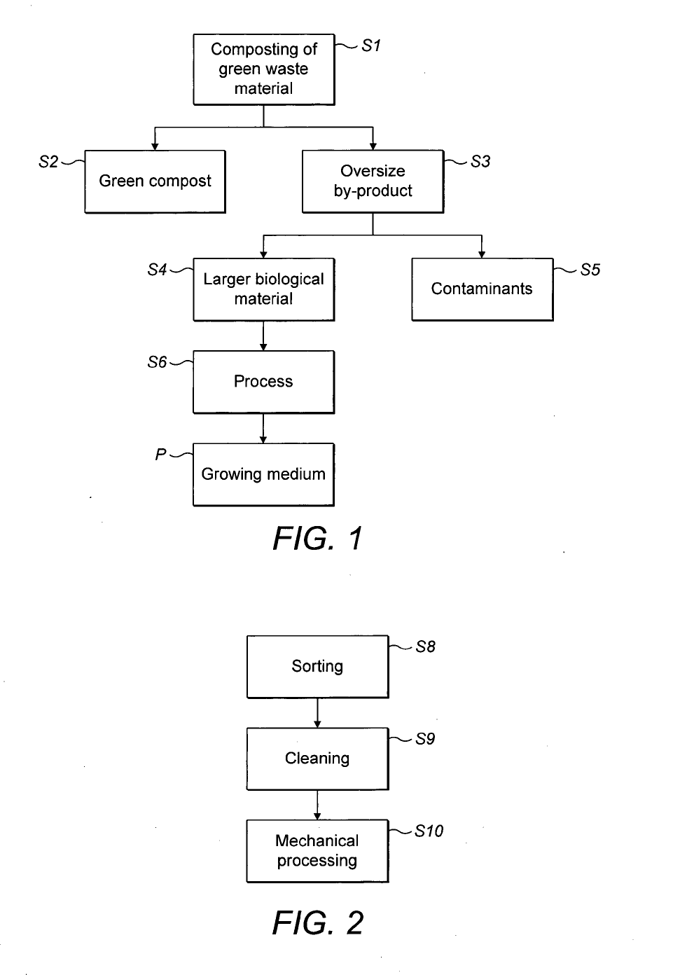

FIG. 1 shows an overview of a process which uses that material S3, which is a by-product of a composting process, S1 to produce a useable growing medium P. The overall process includes the steps of:
1. Conventional composting S1 of mixed green waste material.
2. Separating the useable composted material S2 from the oversized by-product S3.
3. Separating the oversized biodegradable material S4 from the contaminants S5.
4. Processing S6 the oversized biodegradable material S4 to produce a growing medium P.

The composition of the green waste material varies depending on the source of the material. The material may originate from one or several places, including forestry work, domestic gardening, public park maintenance, agriculture or any other source of green waste material. This mixture of material includes components that will decompose into compost during the normal composting process, in particular smaller components such as grass cuttings, leaves, small twigs and other small biodegradable matter that will degrade relatively quickly into compost. However, larger component materials, such as tree branches, twigs and roots and other larger pieces of wood or other biodegradable matter, will not decompose during the normal composting process. Furthermore, contaminant materials, for example plastic bags, golf balls and glass bottles, may be mixed into the material and these will not decompose at all, so will remain combined with the oversize material after the composted material has been removed.

At the end of the composting process S1 the material is passed over a screen which separates the composted material S2 (which is small enough to pass through holes in the screen) from the non-composted by-product S3 (which is too large to pass through holes in the screen). The biodegradable components S4 of the by-product material S3 have excellent potential to create a high quality and useful growing medium because they have absorbed nutrients during the composting process and once broken down will be a stable material that both holds lots of water and yet is sufficiently structured to retain air. However, as previously described, it is not presently viable to separate out the contaminants S5 and compost the remaining biodegradable material S4, so it is disposed of by landfill.

The process and apparatus described hereinafter takes the by-product material S3 of the composting process and, as shown in FIG. 1, removes the contaminants S5 before processing S6 the biodegradable components S4 to produce a useable growing medium P.

This process makes use of an otherwise waste material and eases the strain placed on landfill sites. Furthermore, the process makes uses of an entirely recycled material to produce a growing medium useful in many commercial and domestic applications. The growing medium produced by the process may be used as a substitute for peat and overcome many of the environmental and horticultural disadvantages of extracting and using peat.

FIG. 2 is a diagram showing an overview of the process of producing a growing medium from an initial material which comprises a mixture of oversize biodegradable material and contaminants, as described above. The process includes the steps of:
S8. Sorting the initial material to remove large contaminant objects.
S9. Cleaning the initial material to remove mineral contaminants, such as salts and sands.

S10. Mechanically processing the remaining material to defibrate the biodegradable material and produce a useable growing medium.

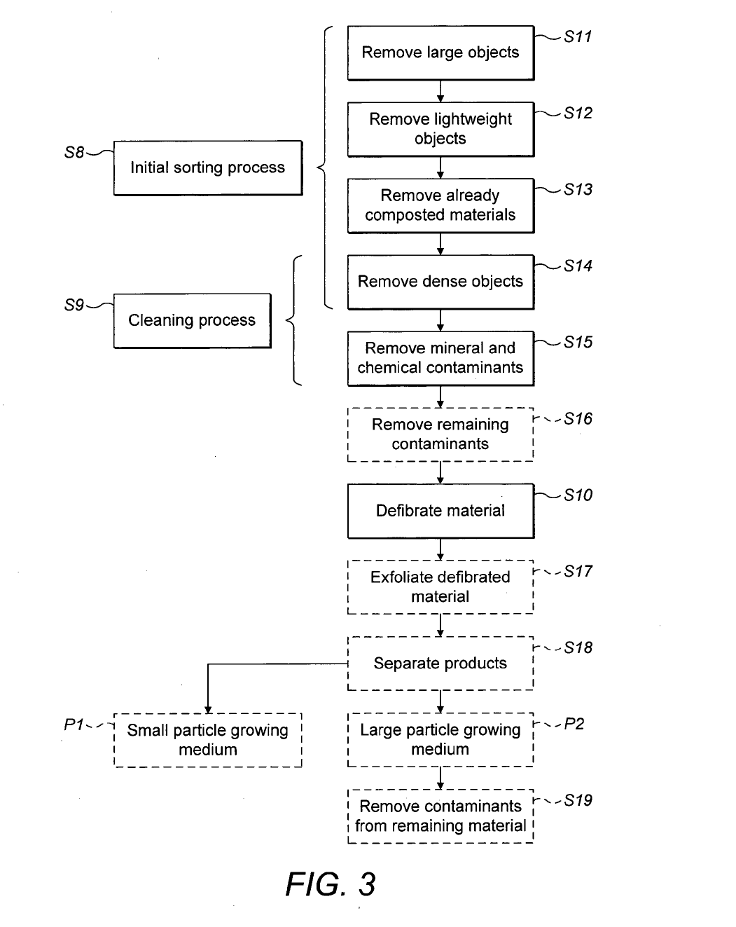

FIG. 3 shows a more detailed process diagram of the steps which may be undertaken to enact the process described with reference to FIG. 2. In particular, the initial sorting process S8 of removing contaminant objects from the initial material involves separating already composted material and large and lightweight contaminants from the initial material. The initial sorting process includes the steps of:
S11. Removing objects which are too large;
S12. Removing lightweight contaminant objects;
S13. Removing material which has already composted; and,
S14. Removing dense contaminant objects, such as stones.

The first stage of this initial sorting process S8—removing large contaminant objects S11—may involve passing the initial material over a screen which comprises a plurality of holes through which material can pass if it is of an acceptable size. The size of the holes in the screen may be for example 80 mm, so that material that is larger than 80 mm is retained on the screen and can be removed from the initial material. However, it will be appreciated that the size of the holes in the screen may be any size, for example any size between 40 mm and 120 mm, depending on the subsequent processes and equipment and their capabilities.

The screen may be a trommel screen which has a cylindrical shape with holes formed in the cylindrical walls. The cylindrical screen is inclined and rotated while the initial material is fed into one end. As the material moves through the rotating screen, material can pass through the holes and be collected underneath the screen. Meanwhile, larger objects will not pass through the holes and will be conveyed to the other end of the screen and can be collected separately.

Material that is too large for this first process may be passed through an industrial shredder, or similar process, to reduce its size so that it can be passed into the system once again.

The second stage of this initial sorting process S8—removing lightweight contaminant objects S12—may involve use of a wind sifting machine that blows air over and/or through the material. The air flow will blow away lightweight objects such as plastic bags and plastic bottles which can be collected separately and disposed of in an appropriate manner.

However, it will be appreciated that the step of removing lightweight contaminant objects may comprise any other means for removing those objects. For example, a manual sorting line or any other machine that can identify those objects and remove them.

The third stage of this initial sorting process S8 involves removing material which has already composted S13 and can be used in conventional compost products. The initial material is a by-product of a composting process and some compost will inevitably remain stuck to the larger material or clumped together. The composted material can be separated out by passing the material through a trommel screen, similar to that previously described, with holes of about 20 mm in size. However, it will be appreciated that the screen for removing already composted material may have holes with a size of any size, in particular, from 5 mm to 40 mm, depending on the nature of the initial material.

The already composted material has small particles which can pass through the holes in the screen and can be collected from beneath the screen and used in conventional compost products. The remaining material will be retained on the screen and will pass through the cylindrical screen to an end where it is collected for further processing, as described below.

The next stage of the initial sorting process S8 comprises removing dense objects S14, such as stones, glass, metal objects and other contaminants. The means for removing dense objects may be a water vortex separator. In this case, water is caused to move around a tank to form a vortex, while the material is fed into the top of the tank. In the tank, dense objects in the material will sink to the bottom of the tank and can be collected and disposed of. Meanwhile, less dense material, including the biodegradable material such as branches, twigs and roots, will float and be carried around the tank by the vortex. The tank will also comprise an exit chute over which some of the water at the top of the tank flows. As the water flows over the exit chute the less dense material is carried with it. In this way, dense contaminant materials can be removed from the initial material.

The process of removing dense objects, as described above, will remove objects with a high specific gravity compared to water. Objects with a high specific gravity will more quickly sink in the water and will be separated from material having a lower specific gravity compared to water, for example branches and roots.

It will be appreciated that the apparatus used in the process described with reference to FIG. 3 may be replaced by other process steps that have the same result. For example, other types of sorting apparatus may be used in place of the trommel screens and a vibrating table may be used to separate out the more dense material. Nevertheless, the process will include the use of apparatus having the means to remove contaminant objects from the initial material.

It will be appreciated that the screening processes described are means for separating components of a material according to their size and this can be replaced with any similar apparatus or means for achieving this. For example, rather than using a cylindrical trommel screen the process may include use of a planar screen or any other means for separating the material into components according to size.

If any of the initial process steps involve the use of water then that step will also at least partially remove chemical or mineral contaminants from the material, such as salts and other residue. These mineral and chemical contaminants are removed from the material prior to processing to ensure a good quality product with an appropriate chemical balance and also to protect the apparatus used in subsequent processes, as will become apparent. These mineral contaminants can be washed away with water.

However, as shown in FIG. 3, the process may include a step of removing mineral and chemical contaminants S15 that is independent of the steps of the initial sorting process. For example, the material may be passed through a trommel wash screen or similar washing process where water is sprayed over the material to dissolve and/or wash away the unwanted mineral and chemical contaminants.

A trommel wash screen comprises a rotating trommel screen, as previously described, with small holes so that all of the material is retained within the screen. Water is sprayed over the material in the screen which washes away or dissolves the mineral and chemical contaminants. The water will pass out of the screen through the holes while the washed material is retained in the cylindrical screen and collected at the end of the screen.

It is very important to remove mineral contaminants and other residues from the material to ensure that the growing medium being produced has the desired characteristics and the apparatus is protected. In particular, salts are undesirable in a growing medium and are washed away in the step of removing mineral and chemical contaminants S15. Moreover, salts and sands may cause damage to downstream processing apparatus and should be removed to ensure that the apparatus remains reliable and effective.

The sorted and washed material may then optionally be passed through a further sorting process S16 to remove as many of the remaining contaminant objects as possible. For example, the material may be conveyed such that it falls through a sorting unit that identifies contaminants using an optical system and removes those materials using an actuator. The sorting unit may comprise a laser based or camera based optical identification system to identify contaminant materials passing through the unit and an air jet or mechanical arm to push those contaminant materials out of the material flow, onto a different conveyor or into a hopper. In this way, contaminant objects are optically identified and removed from the material.

However, it will be appreciated that other means for removing contaminant objects may be used in place of the optical sorting unit described above. Contaminant objects may be identified using an optical sensor, as described, or by any other means, for example an ultrasound sensor.

It will be appreciated that the initial sorting process S8 described above, with reference to FIG. 3, comprises at least means for removing contaminant objects and means for removing contaminant minerals. The apparatus used to achieve this may vary and the apparatuses described above are merely examples. Other apparatus may be used, for example a magnetic or eddy current system to remove metal objects, or a manual sorting process to remove other contaminant objects. The removal of large component materials and already composted material is optional and depends on the nature of the initial material. For example, the initial material may have already been sorted prior to the composting process and the compost may have already been thoroughly removed from the initial material, in which case these steps may not be necessary.

After passing through the initial sorting process S8 and cleaning process S9, as shown in FIG. 2 and described above, the material will now comprise mostly oversized biodegradable material, such as branches, twigs and roots, with some contaminant materials remaining. As shown in FIGS. 2 and 3, the remaining material is processed S10 to produce a useable growing medium P, P1, P2. The remaining material is passed through a processing unit which mechanically breaks apart the material to defibrate the wood components and thereby create a growing medium.

In particular, the wood can be either subjected to pressure or it can be twisted to shear apart the material and cause the fibres to separate. This reduces the size of the pieces of material as the pieces are pulled apart. This also greatly increases the surface area of the material, improving the bulk density and water retention properties. The wood material may be subjected to both pressure and shear forces to defibrate the material.

Defibration means to at least partially separate the constituent fibres of a material. In this case, defibrating the biodegradable material will at least partially separate the natural fibres of the material.

In one example, the material is pressed against a plate while being rotated so that the material is both under a compressive force and a shear force which causes the material to be broken up into smaller parts and also causes the material to defibrate.

The effect of the material being rotated whilst being under pressure results in it being sheared, ripped and/or broken apart to separate the fibres. This is an important aspect of the invention, as it is this defibration of the material that produces a growing medium of the required consistency, surface area and bulk density.

This defibration process produces a material that can be used as a growing medium. The defibrated material has an increased surface area, reduced particle size and is biodegradable. Therefore, the material is suitable for use a peat substitute, as an independent growing medium, a mulching product, or for blending with other growing mediums for different applications. Moreover, the initial material will have absorbed nutrients from the compost during the composting process and the defibrated material is a stable material that both holds lots of water and yet is sufficiently structured to retain air. Therefore, the defibrated material has many characteristics that are desirable for a growing medium.

The defibrated material which exits the processing unit may be bunched together and as shown in FIG. 3 an optional exfoliating process S17 may be used to break apart this bunched defibrated material. This will avoid large lumps of growing medium being mixed in with loose particles, which would cause the bulk density and other characteristics of the product to vary. The exfoliating process S17 may comprise vibrating or turning the material or may include rubbing the material and pulling it apart the fibres.

As shown in FIG. 3, an optional further screening process S18 may be used to sort the processed material into different products. For example, a screening process S18 may be used to sort the growing medium into a product having small particles P1 and a product having large particles P2. The small particle product P1 may be suitable for use as a growing medium independently while the larger particle product P2 may be used in a blended growing medium.

Alternatively, the large particle product P2 may be passed through a further sorting process S19 to remove remaining contaminant objects. This process S19 may comprise an optical identification system and actuator to identify and remove contaminant objects, as described earlier. The large biodegradable material remaining in the large particle product P2 may be used as a mulching product or alternatively fed back into the defibration process S10 so that it is further defibrated and broken down to produce a small particle growing medium.

It will be appreciated that the process described with reference to FIGS. 2 and 3 comprises several individual steps and the order and/or process of each step may be varied while still falling within the invention defined in the claims. In particular, the sorting and cleaning processes S8, S9 may use any substitutable process or apparatus to remove contaminant objects and minerals from the initial material. Furthermore, the order in which the material is processed may be altered, for example the material may be processed before the contaminants are removed. It will be appreciated that the concept of the invention is not limited to the exact process described with reference to FIGS. 2 and 3 but rather to the concept of removing contaminant objects and minerals from an initial material, which is a contaminated by-product of a composting process, and then defibrating the remaining material to produce a growing medium.

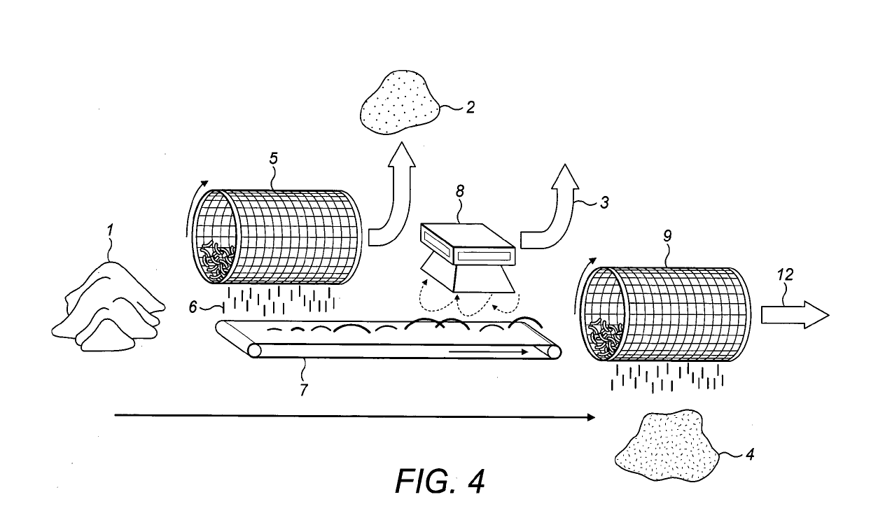

FIGS. 4 to 10 show examples of apparatus that may be used to perform the steps of the process described with reference to FIGS. 2 and 3.

FIG. 4 shows apparatus that may be used to remove large contaminant objects 2, lightweight contaminant objects 3 and already composted material 4 from the initial material 1.

As shown in FIG. 4, the initial material 1 is first fed into a rotating trommel screen 5 with a screen hole size of approximately 80 mm, although this may be anywhere in the range from 50 mm to 150 mm depending on the initial material 1 and the capabilities of the subsequent processes. This trommel screen 5 removes material 2 which is too large (doesn't pass through the screen) and material 6 that does pass through the screen 5 is transported into the subsequent processes. The material 2 which is too large may be disposed of in a conventional manner or may be passed through a shredder or similar machine to cut it into smaller pieces and then passed back into the beginning of the process with the initial material 1.

The material 6 which passes through the first trommel screen 5 is moved, in this case by means of a conveyor 7, through a wind sifting machine 8 to remove lightweight contaminant objects 3, such as plastic bags, plastic bottles and other similar objects that would be blown out of the material 6 by wind. The wind sifter 8 blows air over and/or through the material 6 and lightweight or large objects 3 are carried out of the material and collected separately. However, it will be appreciated that other means for removing lightweight contaminant objects may be used.

The next piece of apparatus is a further trommel screen 9 which in one example has a screen hole size of 20 mm, although it will be appreciated that this screen hole size may be anything between 5 mm and 40 mm. This trommel screen 9 removes any small particles of material that has already decomposed into compost 4. The material which passes through holes in the trommel screen 9 is compost and may be used as a conventional growing medium. The material 12 retained within the trommel screen 9 will be collected at one end of the trommel screen 9 and passed on to subsequent processes.

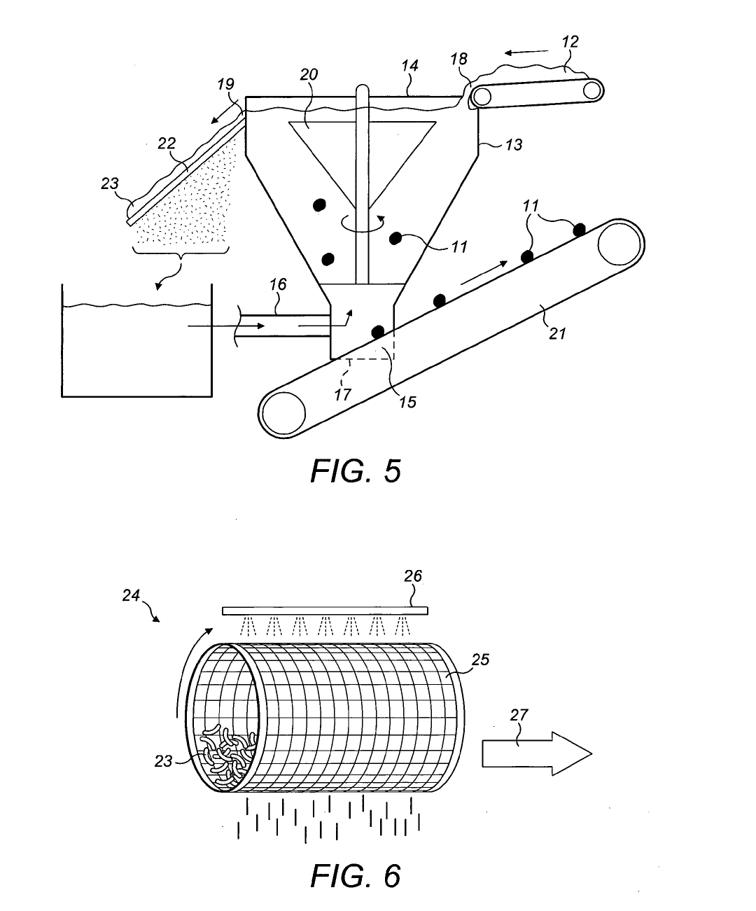

FIG. 5 shows apparatus 10 used to remove dense objects n from the material 12 which has been sorted by the apparatus described with reference to FIG. 4. In this example, the apparatus comprises a water vortex tank 13. The tank 13 comprises a funnel shaped body which is disposed with the wider end 14 facing upwards and the narrower end 15 disposed at the bottom. A water inlet 16 is disposed in a side of the tank 13 towards the narrow end 15 and a dense object outlet 17 is formed in the bottom of the narrow end 15 of the tank 13. Furthermore, a material inlet 18 is formed on one side of the wider top 14 of the tank 13 and a material outlet 19 formed in another part of the wider top 14 of the tank 13. Also, a vortex generating rotary arm 20 is disposed within the tank 13.

Water is pumped into the vortex tank 13 at a rate sufficient to maintain a consistent water level which is above the height of the outlet 19 formed in the wider top 14 of the tank 13, so that water enters the tank 13 through the inlet 16 and flows over the outlet 19. A rotary arm 20, as shown in FIG. 5, rotates within the tank 13 to create a vortex of water turning around within the tank 13.

The material 12 is fed into the tank 13 via the material inlet 18 formed in the wider top 14 of the tank 13 by a conveyor and the material 12 passing through material inlet 18 moves around the tank 13 to the material outlet 19. Once in the tank 13, buoyant and biodegradable material, such as branches, twigs and roots, will float and move around the tank 13 on the surface of the water. Meanwhile, dense objects ii such as stones, pieces of metal and glass will sink and exit the tank 13 through the outlet 17 at the bottom 15 of the tank 13. The outlet 17 is sealed and a conveyor 21 passes through the outlet 17 to collect the dense objects 11 that have been removed from the material 12 and carry them away.

The vortex causes the material 12 to move from the material inlet 18 to the material outlet 19 formed in the top 14 of the tank 13. The biodegradable material will initially be buoyant and will remain at the surface of the water long enough to move from the inlet 18 to the outlet 19. However, if the material is in the tank for too long it may absorb water, loose buoyancy and sink. Therefore, the rate at which the material is fed into the tank, the speed of the rotary arm 20 and the pressure and flow rate of the water inlet 16 need to be balanced to ensure that dense items 11 are removed from the material 12 without loosing much of the biodegradable material.

The material outlet 19 is formed in the top of the tank 13 at a level which is slightly below the level of water maintained in the tank 13 such that water flows over the edge of the tank and through the outlet 19 onto a screen 22. The material 23 which has floated in the tank 13 is carried with the water as it flows through the outlet 19 and the screen 22 allows the water to drain away while the material 23, without the dense objects 11 which have been removed, is retained on the screen 22. The screen 22 may be mounted on a vibrating mount such that the screen is caused to shake and vibrate so that the water drains away more quickly and the material 23 moves along the screen.

It will be appreciated that other apparatus for removing dense objects from the material may be used in place of the water vortex tank described above. For example, a centrifugal or vibration based separation apparatus may be used.

FIG. 6 shows a trommel wash screen 24 which comprises a rotating trommel screen 25 and a water bar 26 which sprays water into the trommel screen 25 as the screen rotates. Material 23 being fed into and through the trommel screen 25 is washed with water. This helps to remove salts and other residue from the material as well as other sand contaminants which may be washed off. These substances are undesirable for the growing medium and should be removed before the material is processed. Moreover, salts and sands may be damaging to the apparatus which is downstream, particularly the defibrating apparatus which makes the growing medium. It is very important to remove these contaminants prior to defibrating the material into a growing medium so that the apparatus is protected and the growing medium being produced does not contain these substances. The washed material 27 exits the trommel wash screen 24 and is conveyed to the next process.

Although FIG. 6 shows a trommel screen washing arrangement 24 it will be appreciated that other types of apparatus that wash the material may be used instead without diverging from the invention as claimed. For example, the material may simply be passed through a water tank or sprayed with water on a flat conveyor. In an alternative example, the water bar 26 may be positioned within the cylindrical trommel screen 25 to spray water directly onto the material 23 being fed into the trommel screen 25.

The apparatus described with reference to FIGS. 4 to 6 may be used to prepare an initial material 1 prior to defibrating that material to produce a growing medium. In particular, the initial material may be a by-product from a composting process, as described earlier, and the apparatus used to remove contaminant objects and contaminant minerals. In particular, the apparatus described can be used to remove objects which are too large 2, remove contaminant minerals by washing, and remove any already composted material 4 prior to processing.

After passing through the apparatus shown in FIGS. 4, 5 and 6, large objects 2, lightweight objects 3 and already composted material 4 have been removed from the initial material 1 and can be used or disposed of separately. Furthermore, any minerals or other chemicals on the surface or mixed in with the material have been mostly washed away. The remaining material 27 is mostly oversized biodegradable material, such as branches, twigs and roots, but it is likely that some contaminant objects will remain. The amount of contamination in this material 27 will depend on the quality and type of the initial material 1, in particular the level of contamination of the initial material 1. The processes described above should remove most of the contaminant objects and minerals to bring the level of contamination down to an acceptable level prior to producing the growing medium.

However, as described with reference to FIG. 3, an optional sorting unit may be used to optically identify and remove contaminant objects prior to the material entering the process unit. In particular, the material may be dropped through a sorting apparatus that uses an optical identification system, such as a laser sensor system or an optical image camera, to identify contaminant objects and activate an air jet removal system, or other type of removal system, to remove that contaminant from the flow of material. It will be appreciated that this step is optional and the apparatus may also be replaced by any other means for removing contaminant objects. For example, an ultrasound sensor or other type of sensor may be used to identify contaminant objects and a mechanical arm may be used to remove them from the material flow. Alternatively, a manual selection process may be used to remove contaminant objects prior to processing.

The material 27 is subsequently passed into the defibration apparatus which mechanically defibrates the material to produce a growing medium. Defibration involves breaking components of the material 27 into constituent fibres. In this case, the wood products will be defibrated by at least partially pulling apart and separating the wood fibres so that the size of the particles is reduced while increasing the surface area. This means that the otherwise difficult to use oversize biodegradable material can be used to manufacture a growing medium.

The defibrated material will have improved water retention properties, as well as improved bulk density and decomposition rate compared to the unprocessed material.

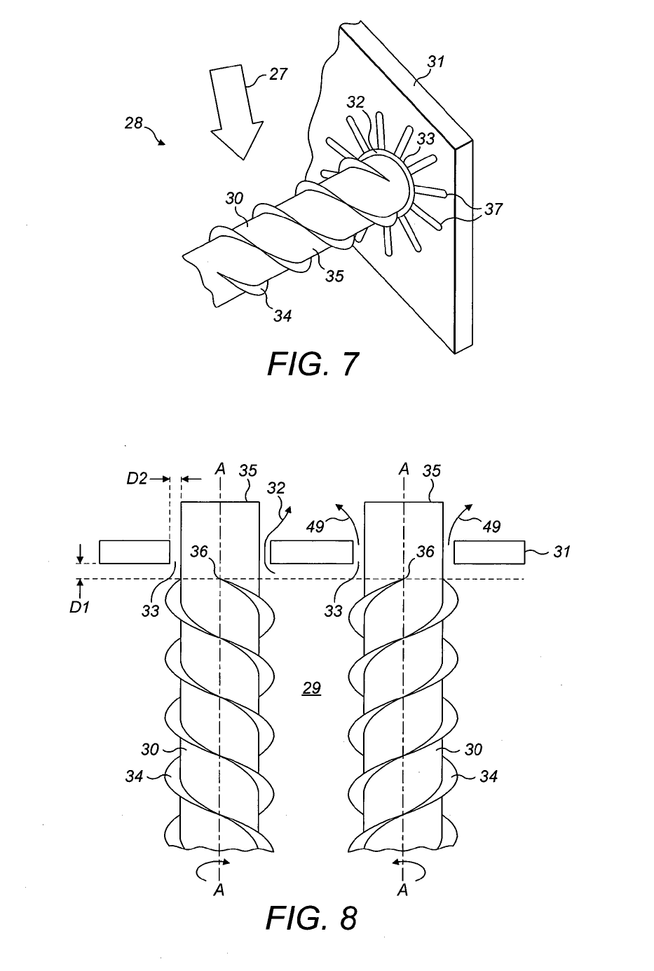

The processing apparatus 28 for defibrating the sorted and washed material 27 is shown in FIGS. 7, 8 and 9. In this example, the defibrating apparatus 28 comprises a processing chamber 29 and at least one feed screw 30 which extends through the chamber 29 and urges the material 27 in one direction. In particular, the chamber 29 comprises a plate 31 and the feed screw 30 pushes the material 27 against the plate 31 and along an exit path 32 formed between the end of the feed screw 30 and an aperture 33 in the plate 31. In the example described hereinafter the defibrating apparatus 28 comprises two feed screws 30 which rotate relative to the plate 31 within a processing chamber 29. However, it will be appreciated that the defibrating apparatus 28 may comprise any number of feed screws.

FIG. 7 shows a view of one of the feed screws 30 and the plate 31 which forms a part of the chamber 29. The rest of the chamber 29 and the second feed screw are omitted for clarity. As shown in FIG. 7, the feed screw has at least one helical fin 34 which extends along a central shaft 35 that extends through the chamber 29 and the sorted and washed material 27 is fed into the chamber 29 through an open top of the chamber. The plate 31 comprises a circular aperture 33 through the plate 31 into which the central shaft 35 of the feed screw 30 may extend. The central shaft 35 may extend through the aperture 33, partially into the aperture 33 or it may not extend into the aperture 33 at all.

However, as shown in FIG. 8, the helical fins 34 of the feed screws 30 do not extend as far as the end of the central shaft 35 and the ends 36 of the helical fins 34 are axially spaced from the plate 31 by an axial spacing D1. Moreover, if the central shaft 35 extends into the aperture 33 then a radial spacing D2 will be formed between the outer surface of the central shaft 35 and the aperture 33. In this way, defibrated material can pass along the axial spacing D1 and through the radial spacing D2 to exit the defibration unit 28. The material exit path 32 is formed between the edge of the central shaft 35 of the feed screw 30, the ends 36 of the helical fins 34 and the aperture 33 and the defibrated material 49 can exit the defibrating apparatus 28 along this path 32.

The feed screws 30 rotate to push the material 24 towards the plate 31 and place the material under pressure. As the material is pushed against the plate 31 the pressure splits the fibres in the wood causing the material to break into smaller particles and defibrate. These smaller particles of defibrated material 49 will then fit through axial spacing D1 and radial spacing D2 and can pass along the exit path 32 to the other side of the plate 31 where a conveyor or hopper will collect the defibrated material 49.

Furthermore, as the feed screw 30 rotates the material will be subjected to a shear force as the material is also caused to rotate relative to the plate 31 while the pressure against the plate 31 creates an opposing friction. The shear force will also cause the material to break into smaller particles and defibrate so that the material can pass along the exit path 32 between the helical fins 34, the aperture 33 and the feed screw 30.

Also shown in FIG. 7, the plate 31 may optionally be provided with one or more recesses 37 or grooves positioned around the edge of the aperture 33. In this case, the plate 31 comprises a plurality of recesses 37 that extend from the aperture 33 outwards in a radial direction. The recesses 37 are cut into the plate 31 but only extend partially through the plate 31. This creates a series of edges around the aperture 33 against which the material is pressed during the defibration process. These edges interact with the material as the material is pressed against the plate and rotated relative to the plate 31 so that the edges increase the rate and amount of defibration and therefore improves the operation of the defibration apparatus 28. In particular, the grooves result in faster and more effective defibration of the material.

FIG. 8 shows a plan view of two feed screws 30 in the defibration apparatus 28. Each feed screw 30 has at least one helical fin 34 that extends along a central shaft 35 and ends at a fixed distance D1 from the plate 31. The central shafts 35 of each feed screws extend into the aperture 33 in the plate 31 and may extend through to a bearing mount on the other side of the plate 31. The rotation of the shaft 35 causes the helical fins 34 to urge the material in a direction parallel to the longitudinal axes A-A of the feed screws 30. The feed screws 30 are coupled to a rotary actuator (not shown) at one end to rotate the feed screws 30 relative to the plate 31. In this example, the feed screws rotate in opposite directions, so that the material is mixed within the chamber, although it will be appreciated that the feed screws may rotate in the same direction. The apertures 33 are larger than the diameter of the central shaft 35 of the feed screws 30 on which the fins 34 are mounted and the ends 36 of the helical fins 34 are spaced from the plate 31 so that as the material is pushed along the feed screws 30 it is forced against the fixed surface of the plate 31, along the exit path 32 and out of the defibration apparatus 28 through the space between the central shaft 35 and the aperture 33.

The pressure and rotational movement created by the feed screws causes the material to break apart and defibrate into a growing medium which consists of fibres and strands of material which may be partially joined together. The size of the axial spacing D1 between the ends 36 of the helical fins 34 and the plate 31 and the size of the radial spacing D2 between the central shaft 35 of the feed screws 30 and the aperture 33 can be selected to determine the particle size of the growing medium. For example, if a small particle size growing medium is desired then the size of the axial spacing D1 or radial spacing D2 can be reduced so that the material must be broken apart more before exiting the defibration apparatus 28 along the exit path 32. On the other hand, if a large particle growing medium is desired then the axial and/or radial spacing D1, D2 can be increased in size.

Adjusting the size of the radial spacing D2 between the central shaft 35 of the feed screw 30 and the aperture 33 will affect the compressive pressure that the material is placed under in the defibration unit 28. On one hand, if the radial spacing D2 is small then less material can flow along the exit path 32 and the pressure generated by the feed screws 30 is increased. This increased pressure will lead to the material being defibrated into smaller parts but may also cause the defibrated material to clump together or be broken down too much, into a dust. On the other hand, if the radial spacing D2 is large then the material may not be defibrated enough to produce a growing medium with the desired characteristics. Therefore, the radial spacing D2 should be selected to provide the desired characteristics. For example, the radial spacing D2 may be between 15 mm and 25 mm in size.

The size of the axial spacing D1 can be altered by moving the plate 31 relative to the feed screws 30 in a direction parallel to the longitudinal axes A-A of the feed screws 30, to change the distance between the ends 36 of the helical fins 34 and the plate 31. The size of the radial spacing D2 may be altered by changing the size of the central shaft 35 of the feed screws 30, by changing the size of the apertures 33 in the plate 31, or by adding an insert or attachment to either the feed screws 30 or to the plate 31.

The defibration process involves placing the material under pressure and rotational movement which will cause friction, resulting in the crushing and tearing of the material. Therefore, the temperature of the material will increase during defibration and this may help to break apart and sanitise the material, which is important for creating a long-lasting and effective growing medium. The heat may cause the material to become dry and, depending on the constituents of the initial material, water may be added to reduce the amount of heat generated in the material. If the material becomes too hot and dry it may simply crumble into a dust and this is not desirable for a growing medium.

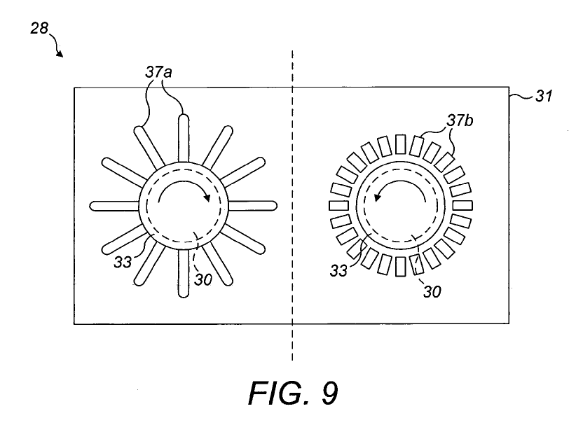

FIG. 9 shows two different examples of grooves 37 that may be formed on the face of the plate 31, around the apertures 33. In one example, shown in FIGS. 7 and 9, the grooves 37a are straight cut in a direction extending radially away from the aperture 33 and joining with the aperture 33 itself. In another case, shown in FIG. 9, the grooves 37b do not extend into the aperture 33 but are positioned around the edge of the aperture 33. It will be appreciated that the grooves 37a, 37b may be formed of any shape or configuration on the face of the plate 31 around the aperture 33 so that the material is pressed against and twisted relative to the grooves 37a, 37b during defibration. The grooves 37a shown in FIG. 7 and on the left in FIG. 9, which extend into the aperture 33, may ease the movement of the material from the face of the plate 31 towards the aperture 33 and along the exit path 32 between the aperture 30 and the feed screw 30.

Although the plate 31 described above has grooves 37 cut into the face which help to break apart the material, it will be appreciated that the plate 31 may instead comprise protrusions which achieve the same effect—providing an edge relative to which the material is moved to improve defibration.

In one example, the axial spacing D1 between the ends 36 of the helical fins 34 of the feed screws 30 and the plate 31 is 25 mm, although it will be appreciated that, as previously explained, the size of the axial spacing D1 may be adjusted to produce different growing media and may fall anywhere in the range from 5 mm to 50 mm. The size of the axial spacing D1 may also be adjusted depending on the size of the material being fed into the defibration apparatus 28.

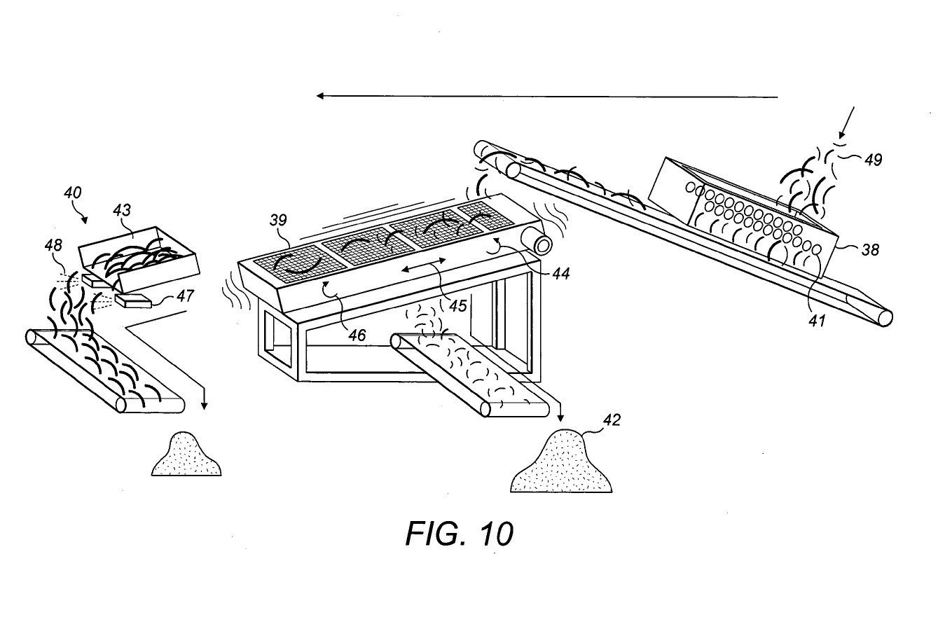

Once the material has been defibrated by the apparatus 28 described with reference to FIGS. 7 to 9, the defibrated material 49 is optionally passed through an exfoliator 38, a further screen sorter 39 and/or further apparatus for removing contaminants 40, as shown in FIG. 10.

In particular, an exfoliator 38 may be provided to break apart the material 49 that is exiting the defibration apparatus that may be clumped or joined together. The exfoliator 38 may comprise means for pulling the defibrated material 49 to separate the fibres and create a more evenly distributed growing medium. In this example, the exfoliator 38 comprises a plurality of rollers 41 being driven at varying speed, through which the defibrated material 49 is passed. In this way, the material 49 is pulled apart and the defibrated material 49 which may have become lumped together and intertwined is separated.

Subsequently, a screen sorter 39 may separate smaller particles 42 of the defibrated material 49 from larger particles 43. Similarly to previously described screening apparatus, smaller particles 42 will pass through the screen 39 and these smaller particles 42 may be collected and used as a growing medium. Larger particles 43 which are retained on the screen 39 may be used as a mulching product, an independent growing medium or they may be passed back into the defibration apparatus to be further defibrated.

The screen sorting apparatus 39 may comprise a shaking or vibrating table that shakes the material to separate the larger and smaller particles so that the smaller particles fall through holes in the table and are collected. As shown in FIG. 10, the screen sorting apparatus 39 may comprise a table with a plurality of holes which is configured to shake so that material placed on the table falls through the holes. In this example, the table moves sequentially through three different actions: a first rotation in a first direction, as shown by arrow 44; a linear movement as shown in arrow 45; and, a third rotation in a second direction, as shown by arrow 46. However, it will be appreciated that the shaking movement may be any movement and may comprise a simple vibrating action. The defibrated material will be separated out and smaller particles 42 will pass through the holes in the table to be collected separately.

The larger particles of material 43 which are retained on the screen 39 will most likely comprise more of the remaining contaminant material which was not removed prior to defibration. Therefore, this larger material 43 may continue into a further sorting apparatus 40 that removes remaining contaminant objects. This sorting apparatus 40 may comprise a conveyor that drops the material 43 past a laser based optical sensor 47 which identifies contaminant objects in the material flow. Once a contaminant object has been identified, an air jet 48 is activated which blows the contaminant object out of the material flow and into a separate conveyor or hopper for collection.

It will be appreciated that the apparatus described with reference to FIGS. 4 to 10 may all be linked together using conveyors, such as belt conveyors, air conveyors or other means of conveying the material through the apparatus automatically. However, it will also be appreciated that the apparatus may be separate and a manual process is required to move the material from one apparatus to the next. Moreover, material may be stored in between the different processes, for example to allow the material to dry after washing prior to entering the next process.

However, it will be appreciated that the apparatus described with reference to FIG. 10 is all optional and the material 49 exiting the defibration apparatus 28 is suitable as a growing medium itself. Furthermore, the apparatus described with reference to FIG. 10 may be replaced by apparatus which performs the same or similar function but in a different manner. The apparatus described with reference to FIG. 10 provides means for pulling apart the particles of the defibrated material, optionally sorting the defibrated material based on its particle size, and optionally removing more contaminant objects. The apparatus described with reference to FIG. 10 may include other means for removing contaminant materials, such as a magnetic or eddy current system. Moreover, an electrostatic charge may be used to remove small plastic contaminants that would be attracted to the charge. For example, an electrostatically charged plate may be positioned over a conveyor along which the material travels. Small plastic contaminants will be attracted to the charged plate and thereby removed from the material. This electrostatically charged plate may be provided to remove contaminants from the material at any point in the apparatus described with reference to FIG. 10 or after the sorted growing medium leaves the process.

The growing medium manufactured by the process and apparatus described above will comprise defibrated wood and other biodegradable materials. The defibration separates the bonded fibres in the biodegradable material and increases the surface area of the material. This will increase the water retention qualities of the material as well as speed up the biodegradation process. Moreover, as previously explained, the biodegradable constituents of the by-product of a composting process have excellent qualities for use as a growing medium as nutrients have been transferred into that material from the compost during the preceding composting process. Therefore, by defibrating that material and manufacturing a useable growing medium an otherwise waste product has been turned into an effective, cheap and high quality growing medium which is made from an entirely recycled and otherwise waste initial material.

The growing medium manufactured by the process and apparatus described hereinbefore may comprise a bulk density of between 100 kilograms/cubic metre and 300 kilograms/cubic metre. Alternatively, the bulk density may be between 150 kilograms/cubic metre and 250 kilograms/cubic metre. Preferably, the bulk density may be between 180 kilograms/cubic metre and 220 kilograms/cubic metre, for example about 200 kilograms/cubic metre.

The bulk density of the growing medium will depend on the degree of defibration and the size and type of initial material fed into the defibration apparatus. Wood generally has a much higher density of between 400 kilograms/cubic metre and 1000 kilograms/cubic metre so the defibration process reduces the bulk density of the source material which is desirable for growing media.

A growing medium manufactured by the process and apparatus described above from the waste initial material by-product will also have a pH of between 5.0 and 8.0. This is advantageous for decomposition of the growing medium as microorganisms operate best under neutral-acidic conditions.

Moreover, the growing medium manufactured by the process and apparatus described with reference to FIGS. 1 to 10 from the previously described oversized by-product of a composting process will have electrical conductivity of between 100 microSiemens/centimetre and 600 microSiemens/centimetre. Electrical conductivity is an indication of the amount of nutrients in the growing medium, and the above stated range makes this growing medium suitable for use as a growing medium but not as an organic fertiliser. The nutrients were released during the preceding composting process and further nutrients will be released as the growing medium biodegrades. The high surface area and small size of the fibres in the defibrated material of the growing medium results in good water retention properties, which protects roots against excess water and provides good soil structure.

The above stated characteristics are similar to those for peat, only peat is generally more acidic. However, the growing medium manufactured by the process and apparatus described with reference to FIGS. 1 to 10 from the previously described oversized by-product of a composting process is an adequate substitute for peat due to its water retention properties. Furthermore, the growing medium of the invention is a recycled material, making use of material that would otherwise go to landfill, whereas peat is a non-renewable fossil fuel.

Many modifications and variations of the invention falling within the terms of the claims will be apparent to those skilled in the art and the foregoing description should be regarded as a description of the preferred embodiments only.

1. A process of manufacturing a growing medium from an initial material, wherein said initial material is a by-product of a composting process and comprises a mixture of oversize biodegradable material and contaminants, the process comprising:
removing contaminant objects from the initial material;
removing mineral contaminants from the initial material; and
subsequently defibrating the remaining material to produce a growing medium.

2. The process of claim 1, wherein defibrating the remaining material comprises applying pressure to said remaining material.

3. The process of claim 1, wherein defibrating the remaining material comprises rotating said material to apply a shear force to the remaining material.

4. The process of claim 2, wherein defibrating the remaining material comprises reducing the size of the remaining material such that the remaining material is able to pass through a spacing having a pre-determined size.

5. The process of claim 4, wherein the spacing is between 10 mm and 40 mm in size.

6. The process of claim 2, wherein defibrating the remaining material comprises using a feed screw configured to press the remaining material against a surface.

7. The process of claim 1, wherein removing contaminant objects comprises removing objects which are larger than 80 mm in size.

8. The process of claim 1, wherein removing contaminant objects comprises removing objects with a high specific gravity compared to water.

9. The process of claim 8, wherein removing contaminant objects comprises passing said initial material through a water vortex system configured such that objects having a high specific gravity compared to water will sink through the water vortex and are removed from the system and objects having a lower specific gravity compared to water will pass across the top of the water vortex and be removed from the water vortex system.

10. The process of claim 1, wherein removing contaminant objects comprises removing material which is smaller than 20 mm in size.

11. The process of claim 1, wherein removing contaminant objects from the initial material comprises passing air over and/or through the initial material to remove lightweight objects.

12. The process of claim 1, wherein removing contaminant objects comprises passing said material through a sorting unit comprising an optical identification system to identify contaminant objects and a means for removing the identified contaminant objects.

13. The process of claim 12, wherein passing the initial material through the sorting unit is carried out prior to mechanically defibrating the remaining material to produce a growing medium.

14. The process of claim 12, wherein passing the initial material through the sorting unit is carried out subsequent to mechanically defibrating the remaining material to produce a growing medium.

15. The process of claim 1, wherein removing mineral contaminants from said initial material comprises washing said initial material with water.

16. The process of claim 1, further comprising separating the growing medium produced by the defibration step into a small particle growing medium and a large particle growing medium.

17. (canceled)

18. Apparatus for manufacturing a growing medium from an initial material, wherein said initial material is a by-product of a composting process and comprises a mixture of oversize biodegradable material and contaminants, the apparatus comprising:
means for removing contaminant objects from said initial material;
means for removing mineral contaminants from said initial material; and
a defibration unit configured to defibrate the remaining material to produce a growing medium.

19. The apparatus of claim 18, wherein the defibration unit is configured to press said remaining material against a surface.

20. The apparatus of claim 18, wherein the defibration unit is configured to rotate said remaining material relative to a surface to shear said remaining material.

21. The apparatus of claim 19, wherein the defibration unit comprises a feed screw which rotates to urge said remaining material towards the surface.

22. The apparatus of claim 21, wherein the feed screw comprises a helical fin extending along a longitudinal shaft and the surface comprises an aperture, wherein an axial spacing is formed between an end of the helical fin and the surface, such that defibrated material can pass along the axial spacing and exit the defibration apparatus via the aperture.

23. The apparatus of claim 22, wherein the axial spacing between the end of the helical fin and the surface is between 15 mm and 25 mm in size.

24. The apparatus of claim 22, wherein the surface comprises a recess disposed adjacent to the aperture, so that the remaining material being urged towards the surface by the feed screw will contact the recess.

25. The apparatus of claim 18, wherein the means for removing contaminant objects from said initial material comprises a screen which comprises a plurality of apertures having a pre-determined size, such that objects in the initial material are removed according to their size.

26. The apparatus of claim 25, wherein the screen comprises a plurality of apertures of size 80 mm, to remove objects which are larger than 80 mm in size.

27. The apparatus of claim 25, wherein the screen comprises a plurality of apertures of size 20 mm, to remove objects which are smaller than 20 mm in size.

28. The apparatus of claim 18, wherein the means for removing contaminant objects from the initial material comprises an air separator which passes air over and/or through the initial material to remove lightweight objects.

29. The apparatus of claim 18, wherein the means for removing contaminant objects from the initial material comprises a water vortex separator comprising a tank in which water is caused to rotate in a vortex, wherein said initial material is fed into the top of the tank such that contaminant objects with a high specific gravity compared to water will sink through the water to an outlet in the bottom of the tank, and objects having a low specific gravity compared to water will float and be carried around the tank and be removed via an outlet in the top of the tank.

30. The apparatus of claim 18, wherein the means for removing contaminant objects from the initial material comprises a sorting unit which comprises an optical identification system to identify contaminant objects and a means for removing those identified contaminant objects.

31. The apparatus of claim 18, further comprising a screen configured to separate the defibrated growing medium produced by the processing unit into a small particle growing medium and a large particle growing medium.

32. A defibrating unit for manufacturing a growing medium from a biodegradable material, comprising a feed screw and a surface, the feed screw being rotatable to urge biodegradable material against said surface, wherein the surface comprises a recess having edges, the biodegradable material being defibrated as it is urged against said surface and as it interacts with said edges of the recess.

33. The defibrating unit of claim 32, wherein the feed screw comprises a longitudinal shaft and the surface comprises an aperture, a helical fin extends along the shaft so that an axial spacing is formed between an end of the helical fin and the surface to enable defibrated material to pass along said axial spacing through said aperture and exit the defibration unit.

34. The defibrating unit of claim 33, wherein the shaft and the surface are movable relative to each other to alter the size of said axial spacing.

35. The defibrating unit of claim 34, wherein the axial spacing between the end of the helical fin and the surface is between 15 mm and 25 mm in size.

36. The defibrating unit of claim 33, wherein the shaft extends into the aperture and a radial spacing is formed between the shaft and the surface, through which defibrated material passes.

37. (canceled)

38. A growing medium manufactured from an initial material which is a by-product of a composting process and comprises a mixture of oversize biodegradable material and contaminants, the growing medium comprising a defibrated material having a bulk density of between 100 kilograms/cubic metre and 300 kilograms/cubic metre.

39. The growing medium of claim 38, wherein the pH of the growing medium is between 5.0 and 8.0.

40. The growing medium of claim 38, wherein the electrical conductivity of the growing medium is between 100 and 600 microSiemens/centimetre when determined using a medium:water ratio of 6:1.

41. (canceled)
